(19) United States
(12) Patent Application Publication
(10) Pub. No.: US 2018/0114174 A1
(43) Pub. Date: Apr. 26, 2018

(54) MARKETPLACE FOR UNMANNED AERIAL VEHICLES DATA COLLECTION REQUESTS

(71) Applicant: International Business Machines Corporation, Armonk, NY (US)

(72) Inventors: Gregory F. Boland, Katonah, NY (US); Yu Ma, White Plains, NY (US); Justin G. Manweiler, Somers, NY (US); Kevin E. Siemonsen, New Fairfield, CT (US); Umut Topkara, Scarsdale, NY (US); Katherine Vogt, New York, NY (US); Justin D. Weisz, Stamford, CT (US)

(21) Appl. No.: 15/332,462

(22) Filed: Oct. 24, 2016

(51) Int. Cl. G06Q 10/06; B64C 39/02

(52) U.S. Cl. CPC G06Q 10/063112; B64C 39/024; B64C 2201/108; B64C 2201/141; G06Q 10/06313

(57) ABSTRACT

Aspects of the invention relate to a UAV (drone) data marketplace where requests for UAV services are matched with registered UAVs. Drone operators register in the marketplace drones in their fleet with their capabilities and requesters of drone services make their request in the marketplace. The requests can be a set of data to be collected (e.g., optical images, NIR data, temperatures, etc.) and/or actions to be performed (e.g., deploying spare machinery parts to a tractor in the field), a location from which that data is collected and/or location to which a delivery is to be made, a pipeline of analytics to be performed on the data (e.g., optical recognition, NDVI computation, fertilizer application recommendation), a timeframe in which to collect the data (e.g., “by next week”, “by the end of today”), and a market value for how much the Requester is willing to pay for that data or operation. The marketplace matches the drone service requests with drones registered in the marketplace capable of performing the requested service. The drone operator and the drone service requester form an agreement for a job to be performed.

### BACKGROUND

Aspects of the present invention generally relate to a method, apparatus, and computer program product for managing a fleet of Unmanned Aerial Vehicles (UAV). Specifically, aspects of the invention relate to a UAV data marketplace where requests for UAV services are matched with registered UAVs.

UAVs or drones are small, lightweight unmanned aerial vehicles that are operated either autonomously by onboard computers or by a human operator via remote control. For autonomous flight, drones contain a GPS device that guides them along a sequence of waypoints and enables them to return to their launching point. Drones may carry small payloads, such as sensor packages, cameras, or other types of small objects. The flight time of a drone is a function of its weight, battery capacity, and operating environment (wind). Flight times generally range from 10-15 minutes per battery for helicopter drones and 30-50 minutes for fixed-wing drones.

Drones are becoming increasingly popular in the hobbyist/consumer market. Interest in the commercial use of drones is also increasing as new regulations in the U.S. are being crafted to enable commercial drone flights. Industries that drones will impact include agriculture, cinematography, mining, oil & gas, emergency response, and law enforcement.

An aspect of the invention is matching a data collection requirement with the capacity of drones registered in a marketplace.

### SUMMARY

Aspects of the invention are a method, apparatus and computer readable program for matching requests in the marketplace for drone services with drone operators registered in the marketplace for ensuring that the type of drone service requested can be fulfilled by a drone in the operator's fleet.

In a variation of the invention, matching may result in multiple operators able to accept the request and the first to accept wins the bid, or the job may be offered to a succession of drone operators, or it may be offered to a single drone operator, or it may be offered to drone operator presenting the lowest bid. The choice of matching policy is left to the marketplace operator.

An exemplary marketplace system for managing a fleet of unmanned aerial vehicles (drones) comprises a drone registry for registering drones available to perform drone services; a request registry for registering requested drone service to be performed; and a matching unit for matching requested drone service to be performed with drone available to perform the requested drone service.

An exemplary method of managing a fleet of unmanned aerial vehicles (drones) comprises registering drones in a fleet of drones available to perform service; registering requested drone service to be performed; and matching requested drone service to be performed with drone available to perform the requested drone service.

An exemplary non-transitory computer readable medium having computer readable program for managing a fleet of unmanned aerial vehicles (drones) comprises: registering drones in a fleet of drones available to perform service; registering requested drone service to be performed; and matching requested drone service to be performed with drone available to perform the requested drone service.

The objects, features, and advantages of the present disclosure will become more clearly apparent when the following description is taken in conjunction with the accompanying drawings.

### BRIEF DESCRIPTION OF THE DRAWINGS

FIG. 1 shows a schematic block diagram of a system for performing aspects of the invention.

FIG. 2 is a flow chart of an aspect of the invention.

FIG. 3 is a schematic block diagram of a computer system for practicing various embodiments of the invention.

### DETAILED DESCRIPTION OF PREFERRED EMBODIMENTS

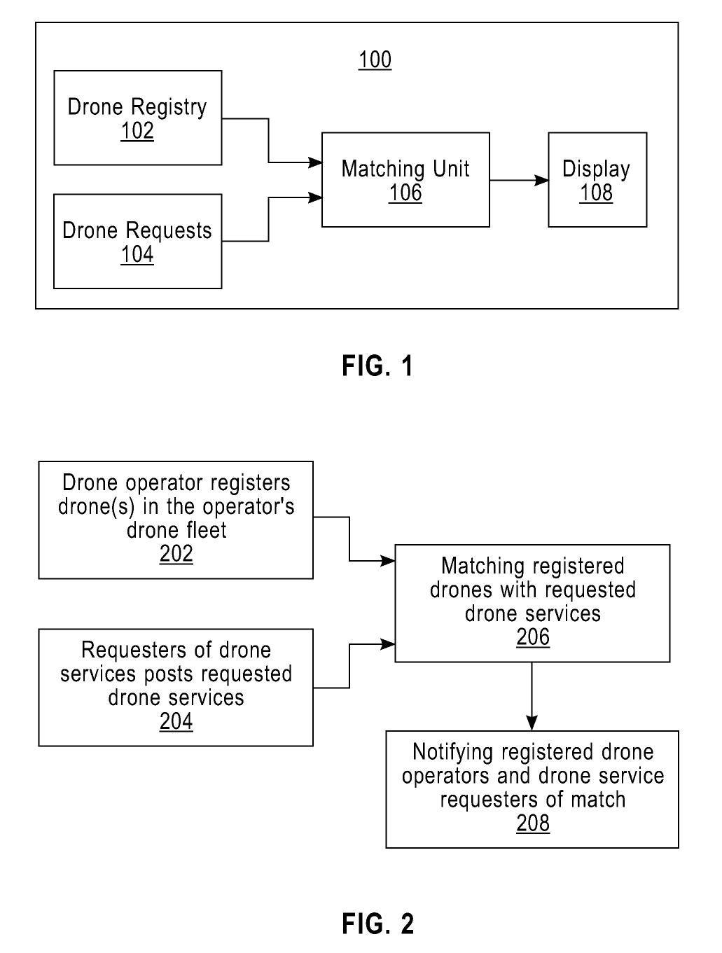

Referring to FIG. 1, there is shown a schematic block diagram of a marketplace system 100 for performing aspects of the invention. Marketplace register memory 102 receives registration input information from drone operators regarding inventories of drones available to perform various functions. The drone registration input information includes, but is not limited to, information regarding the type of drone (quad, octo, fixed wing, etc.) manufacturer, flight time, payload capacity, propeller requirements (e.g., size, material, etc.) and sensor payload (e.g., optical camera, IR camera, NIR camera, temperature sensor, optical flow sensor, and the like).

A marketplace refers to an arrangement where drone operators register drone devices in the marketplace and requesters of drone services make their request in the marketplace. The marketplace matches the requests with drones registered in the marketplace capable of performing the requested service. The drone request may have a dollar amount associated with the request, e.g. “map my field and I will $500”.

The system may include a marketplace for enabling users/requesters to post data collection requests. Each data collection request includes a set of data to be collected, a location from which the data needs to be collected, a pipeline of analytics to be performed on the data, a timeframe to collect the data and a budget for the data collection request. The system may assist a requestor and a service provider with an appropriate budget for a task.

‘Matching’ means matching the capabilities of the drone, e.g. “contains an NIR camera”, to the requirements of the request, e.g. “create an NDVI map of my farm”; an example of a request that does not match the requirements is, “my drone only contains an optical camera” and the request is to “map the temperature of this field”.

Requesters create requests in the Marketplace for drone services by presenting requests to a request device 104. The requests comprise a set of data to be collected (e.g., optical images, NIR data, temperatures, etc.) and/or actions to be performed (e.g., deploying spare machinery parts to a tractor in the field), a location from which that data is collected and/or location to which a delivery is to be made, a pipeline of analytics to be performed on the data (e.g., optical recognition, NDVI computation, fertilizer application recommendation), a timeframe in which to collect the data (e.g., “by next week”, “by the end of today”), and a market value for how much the Requester is willing to pay for that data or operation.

A recommended market value may be computed by identifying prior requests submitted to the marketplace and computing a statistical function of how much Drone Operators were paid for performing those requests. For example, the marketplace may determine a rate of $300/hr for collecting imagery data, and can recommend a bid of $600 for a field that will take 2 hours to image or map.

A matching unit 106 matches the requests for drone services specified in a request with the capabilities of the drones registered in the marketplace. The matching unit ensures that the type of data requested (e.g., NIR data) or the service requested can be fulfilled by a drone in the operator's fleet (e.g., a drone with an NIR camera) registered in the marketplace.

In response to receiving the one or more data collection requests or activity requests, the system matches capabilities of the drones, maintained in drone registry, with the requirements of the requests.

The output of the matching unit is provided to a display 108, electronic message or similar output devices for presenting the results of the matching to a marketplace operator, drone operator, or requester.

The matching unit also matches drones based on geographic proximity; e.g., a request for a farm in Southbury, Conn. will only be matched to drone operators operating within an N-mile radius of Southbury, Conn. (where N may be determined by the marketplace operator, by the drone operator, or by the requester), so a drone operator in Florida will not be considered for the task in Connecticut.

Matching may result in contacting multiple drone operators to accept a job and the first to accept wins the bid, or the job may be offered to a succession of drone operators, or it may be offered to a single drone operator, the choice of matching policy is up to the marketplace operator. The choice making decision may be performed in accordance with a preprogrammed bid acceptance process.

Having matched a requester with a drone operator under mutually acceptable conditions, the selected drone can perform the requested data collection or task.

FIG. 2 is a flow chart of an aspect of the invention.

Drone operators register in a marketplace drones 202, registering among other items, the drones in the operator's fleet of drones including their capabilities and information related to the identity and location of the operator.

Requesters of drone services post requests for drone services in the marketplace 204. The requests include type of data to be collected and/or physical tasks to be performed and/or the like.

The registered drones are matched with drone services requests 206 to identify drones in the marketplace suitable for performing the requested drone service.

The matched drone(s) and requester are notified of the match 208q for the purpose of having the service performed by the operator for the requester using the suitable drone.

The operators and requesters can negotiate an agreement for the drone services to be performed.

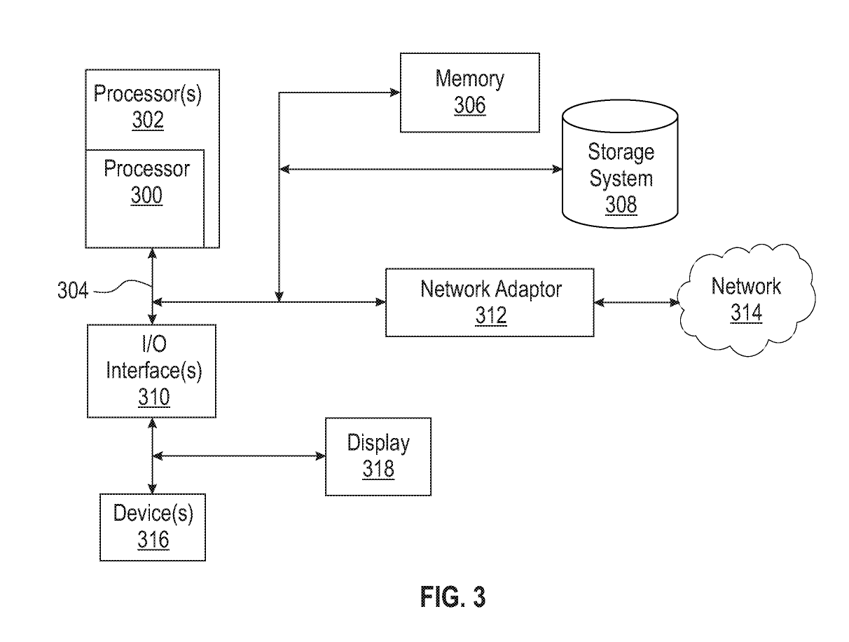

FIG. 3 illustrates a schematic diagram of an example computer or processing system that may implement matching of UAV service requests with a suitable UAV in one embodiment of the present disclosure. The computer system is on one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 3 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 302, a system memory 306, and a bus 304 that couples various system components including system memory 306 to processor 302. The processor 302 may include a module 300 that performs the methods described herein. The module 300 may be programmed into the integrated circuits of the processor 302, or loaded from memory 306, storage device 308, or network 314 or combinations thereof.

Bus 304 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 306 can include computer system readable media in the form of volatile memory, such as random access memory (RAM) and/or cache memory or others. Computer system may further include other removable/non-removable, volatile/non-volatile computer system storage media. By way of example only, storage system 308 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 304 by one or more data media interfaces.

Computer system may also communicate with one or more external devices 316 such as a keyboard, a pointing device, a display 318, etc.; one or more devices that enable a user to interact with computer system; and/or any devices (e.g., network card, modem, etc.) that enable computer system to communicate with one or more other computing devices. Such communication can occur via Input/Output (I/O) interfaces 310.

Still yet, computer system can communicate with one or more networks 314 such as a local area network (LAN), a general wide area network (WAN), and/or a public network (e.g., the Internet) via network adapter 312. As depicted, network adapter 312 communicates with the other components of computer system via bus 304. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

Embodiments of the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A marketplace system for managing a fleet of unmanned aerial vehicles (drones) comprising:
a marketplace
register memory, operably coupled to said marketplace, storing and registering drones available to perform drone services without responding to a request for drone services;
request device, operably coupled to said marketplace, storing and registering requested drone service to be performed; and
matching unit coupled to said drone register memory and said request device matching requested drone service to be performed with drones available to perform the requested drone service and present the results of the matching for drone operators and drone service requesters to select a drone to perform the requested drone service, the selected drone performing the requested service.

2. The marketplace system of claim 1, further comprising display means for notifying that the matching unit found a match.

3. The marketplace system of claim 1, where matches are limited by geographical location of drone and location where drone service is to be performed.

4. The marketplace system of claim 1, where the requested drone service includes a money amount associated with the request.

5. The marketplace system of claim 1, where the registered drone service has a cost associated with the drone service.

6. The marketplace system of claim 1, where the drone register memory input is selected from the group consisting of type of drone, manufacturer, flight time, payload capacity, propeller requirements, and sensor payload.

7. The marketplace system of claim 6, where the sensor payload is selected from the group consisting of optical camera, IP camera, NIR camera, temperature sensor, optical flow sensor.

8. A computer-implemented method of managing a fleet of unmanned aerial vehicles (drones) comprising:
registering and storing in a drone register memory drones in a fleet of drones available to perform services without responding to a request for drone services;
registering and storing in a request device requested drone service to be performed; and
matching in a matching unit requested drone service to be performed with drones available to perform the requested drone service and presenting the results of the matching for drone operators and drone service requesters to select a drone to perform the requested drone service, the selected drone performing the requested service.

9. The method of claim 8, further comprising displaying notification that a match is found.

10. The method of claim 8, where the matching is limited by geographical location of drone and location where drone service is to be performed.

11. The method of claim 8, where the registering drones includes a cost amount associated with a drone service.

12. The method of claim 8, where the requested drone service includes a money amount associated with the request.

13. The method of claim 8, where registering drones available is selected from the group consisting of type of drone, manufacturer, flight time, payload capacity, propeller requirements, and sensor payload.

14. A non-transitory computer readable medium having computer readable program for managing a fleet of unmanned aerial vehicles (drones) comprising:
registering and storing in a drone register memory drones in a fleet of drones available to perform services without responding to a request for drone services;
registering and storing in a request device a requested drone service to be performed; and
matching in a matching unit the requested drone service to be performed with drones available to perform the requested drone service and presenting the results of the matching for drone operators and drone service requesters to select a drone to perform the requested drone service, the selected drone performing the selected service.

15. The non-transitory computer readable medium of claim 14, further comprising displaying notification that a match is found.

16. The non-transitory computer readable medium of claim 14, where the matching is limited by geographical location of drone and location where drone service is to be performed.

17. The non-transitory computer readable medium of claim 14, where the registering drones includes a money amount associated with a drone service.

18. The non-transitory computer readable medium of claim 14, where the requested drone service includes a money amount associated with the request.

19. The marketplace system of claim 1, where the selected drone performing the requested service is controlled by an onboard computer or human operator via remote control.

20. The method of claim 8, where the selected drone performing the requested service is controlled by an onboard computer or human operator via remote control.
